(19) United States
(12) Patent Application Publication
(10) Pub. No.: US 2022/0354076 A1
(43) Pub. Date: Nov. 10, 2022

(54) HYDROPONIC CULTIVATION SYSTEM & LIGHTING SYSTEM

(71) Applicant: 314 PURE CANNABIS LTD., Crossfield (CA)

(72) Inventors: Darren BUELL, Crossfield (CA); Lance BJORDALEN, Crossfield (CA)

(73) Assignee: 314 PURE CANNABIS LTD., Crossfield, AB (CA)

(21) Appl. No.: 17/642,639

(22) PCT Filed: Sep. 11, 2020
(86) PCT No.: PCT/CA2020/051235

§ 371 Date: Mar. 11, 2022

Related U.S. Application Data
(60) Provisional application No. 62/899,000, filed on Sep. 11, 2019.

(51) Int. Cl. A01G 31/02

(52) U.S. Cl. CPC A01G 31/02

(57) ABSTRACT

A system for hydroponic cultivation including a cultivation container that includes an outer bucket having a drain defined in a lower portion. The outer bucket is configured to receive and support a perforated insert for holding a growing medium and tin a root mass/ball of a plant. The cultivation system also includes an elongated trough having an upper portion and a lower portion. The trough defines a longitudinal irrigation channel inclined downwards from a first end towards a second end. The upper portion forms shoulders on opposing sides of the trough for receiving the cultivation container. An irrigation system is also provided to deliver a hydroponic solution to the plant, which includes a delivery unit associated with the cultivation container and is configured to deliver the hydroponic solution to the plant from an upper portion of the cultivation container. A lighting system is also provided to deliver light to portion and side canopies of the plant.

### FIELD OF THE INVENTION

The present invention pertains to the field of indoor plant cultivation/growing. In particular the present invention pertains to a hydroponic cultivation/growing system, and a lighting system for indoor cultivation.

### BACKGROUND OF THE INVENTION

Hydroponics is commonly known as a method of cultivating plants in a water based, nutrient rich solution, without soil, wherein the plants may be suspended or held in an inert medium, such as perlite, gravel, rockwool, clay pellets, peat moss or vermiculite, that provides root anchorage and functions as a temporary reserve of the nutrient solution.

A variety of designs for hydroponic systems have been developed, including the commonly used systems Nutrient Film Technique (NFT) systems, Flood and Drain (Ebb and Flow) systems, Hydroponic Drip systems, Water Culture systems, Passive Wick systems and Aeroponic systems.

The Nutrient Film Technique system is an active hydroponics system, wherein the nutrient solution flows continuously in a thin film over plants' roots to ensure that plants get the required nutrients and hydration without entirely soaking the roots. The purpose of the thin film is to ensure that the upper portions of the roots are completely dry in turn, giving the plants adequate access to oxygen. NFT relies on a continuously running pump to deliver a low but continuous flow of nutrient over the plant roots. Therefore, the pump must be designed for continuous operation.

In the Flood and Drain (Ebb and Flow) system, the plants are flooded with nutrient solution periodically instead of continuously. The plants are grown in porous containers filled with a growing medium, wherein the containers are held in a tray just above the reservoir. The nutrient solution is pumped from the nutrient tank into the grow tray, and a one way valve allows the nutrient to flow into the grow tray only, flooding the roots of the plants. The nutrient then gradually flows back into the nutrient tank.

Drip systems use a nutrient tank and a timer controlled flow pump to saturate an inert growing medium slab holding a plant to retain nutrient solution around the plant roots. Nutrient solution is pumped into a transport pipe, and at each plant position this pipe is tapped into by a delivery pipe, which allows water to flow though at a limited rate. The delivery pipe has a drip stake at the end of it which drips nutrient solution onto the grow medium. The irrigation cycle is set on the pump so that the grow medium receives more than enough nutrient to saturate the slab with excess nutrient draining back down to the nutrient tank. Generally, at least 20% more nutrient is delivered than required to allow any excess build-up of salts in the grow medium to be flushed back into the nutrient tank.

The Water culture system works effectively by suspending plant's roots directly into a nutrient solution 24/7, with plant itself floating on a raft with a hole. The roots are provided oxygen through dissolved oxygen in the water and air bubbles rising in the nutrient solution.

Traditional hydroponic systems each have their own drawbacks. For example, traditional Nutrient Film Techniques (NFT) systems are prone to clogging and failure. NFT's are also typically unable to provide the plant with the correct amount of water, nutrients and oxygen to produce optimal growth and can often lead to plant drowning or stunted growth. NFT and drip watering systems provide continuous flow of water to plants leading to dependence on continuous water flow. In Flood and Drain (Ebb and Flow) system, proper automation and functional reliability is necessary, because if the plant roots are not flooded in time, they dry out resulting in irreparable damage to the plant roots. On the other hand, if the hydroponic solution stagnates in the cultivation container, then the roots rot, again causing irrecoverable damage.

Other cultivation systems such as those described in U.S. Pat. No. 5,394,647, and US Publication Nos. 2013/0074408 and 2018/0139915) suffer from various drawbacks. Some fail to provide a consistent flow of water and nutrients to each plant. Other systems use complicated control valves that lead to higher costs and represent a point of contamination and failure. Other systems are prone to clogging and failure due to plant roots sitting or hanging in the nutrient solution.

Accordingly, there is a need for an improved hydroponic system which can improve plant yield and quality, while minimizing the deficiencies of known systems.

Indoor cultivation of plants also typically employs commercial lighting systems. Historically, this has been with High Pressure Sodium (HPS) lighting, and has shifted to LED lighting in recent years. Indoor cultivation of cannabis plants (soil, hydroponics, aeroponics), generally uses only overhead lighting to grow plants, which provides optimal illumination to the top of the plants only, and provides insufficient lighting on the sides of the plant. As a result, the plants are small in size and provide a harvest of top canopy flowers only. Another problem with indoor lighting systems is that heat is produced in addition to the light, which can adversely affect plant growth as excess heat generally burns the plants.

There is also a need for an improved lighting system for indoor plants, in particular for cannabis plants, which can provide optimal illumination to the top and sides of the plants such that plants can be grown to a desired height with a harvestable top canopy and canopies, without having adverse heat affects.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a hydroponic cultivation system comprising improved growing containers and trough to improve irrigation of the plant roots. The system also provides an irrigation system and a lighting system to improve growth and yields of indoor plants.

In accordance with an aspect of the present invention, there is provided a system for hydroponic cultivation. The system comprises one or more cultivation containers, each including an outer bucket having a drain provided in a lower portion thereof, a perforated insert for holding a growing medium and a plant, and supporting a root mass/ball of the plant, the outer bucket is configured to receive and support the perforated insert; one or more elongated troughs, each trough has a top portion, a bottom portion, a pair of generally opposing side walls that extend longitudinally between a first end, and a second end which comprises a trough outlet, the bottom portion of the trough defines a longitudinal channel inclined downwards from the first end towards the second end, the top portion has opposing shoulders extending outwardly from the side walls, the shoulders are configured to support the one more cultivation containers; and an irrigation system configured to deliver a hydroponic solution from a hydroponic solution source to the one or more plants, the irrigation system comprising one or more delivery units, each delivery unit being associated with a respective cultivation container, and configured to deliver the hydroponic solution to the plant through an upper portion of the respective cultivation container, wherein upon delivery to the cultivation container, the hydroponic solution passes over the growing medium, through the perforated insert, through the drain in the bucket into the channel of the trough, and through the trough outlet at the second end of the trough.

In accordance with another aspect of the present invention, there is provided a lighting system for illuminating one or more plants during a growing cycle, which comprises at least one overhead light source configured to illuminate a top canopy of the one or more plants and a plurality of vertical light assemblies, each light assembly comprising one or more vertically oriented light sources, arranged such that each light source illuminates a portion of a circumference of a plant.

In accordance with another aspect of the present invention, there is provided a method of cultivating one or more plants, which comprises: illuminating a top canopy of the one or more plants with one or more overhead light sources; illuminating at least a portion of a side canopy of the one or more plants with a plurality of vertical light assemblies, each light assembly comprising one or more vertically oriented light sources, arranged such that each light source illuminates a portion of a circumference of the side canopy, the vertical light assemblies being positioned such that one assembly is located adjacent a space between two adjacent plants; and irrigating the one or more plants.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

The invention will now be described by way of exemplary embodiments with reference to the accompanying simplified, diagrammatic, not-to-scale drawings. In the drawings:

FIG. 1 is a schematic depiction of the hydroponic system in accordance with an embodiment of the present invention.

FIG. 2 is a schematic depiction of a cultivation container of the hydroponic system in accordance with an embodiment of the present invention.

FIG. 3A is a schematic depiction of a cross section of the trough in accordance with an embodiment of the hydroponic system of the present invention.

FIG. 3B is a schematic depiction of a cross section of the trough in accordance with an embodiment of the hydroponic system of the present invention.

FIG. 3C is a schematic depiction of front view of the trough in accordance with an embodiment of the hydroponic system of the present invention.

FIG. 4 is a schematic perspective view of a delivery head in accordance with an embodiment of the hydroponic system of the present invention.

FIG. 5 is a schematic bottom view of a delivery head in accordance with an embodiment of the hydroponic system of the present invention.

FIG. 6 is a schematic overhead view of a lighting system in accordance with an embodiment of the present invention.

FIG. 7 is a schematic profile view of a lighting system in accordance with an embodiment of the present invention.

It will be noted that throughout the appended drawings, like features are identified by like reference numerals.

### DETAILED DESCRIPTION OF THE INVENTION

Unless defined otherwise, all technical and scientific terms used herein have the same meaning as commonly understood by one of ordinary skill in the art to which this invention belongs.

As used herein, the term “canopy” refers to the leaves, buds and/or flowers on plant stem(s). A “top canopy” is formed by the leaves, buds and/or flowers at the top portion of a plant, and a “side canopy” is formed by the side branches, leaves, buds and/or flowers at the side the plant.

As used herein, the term “about” refers to a +/−10% variation from the nominal value. It is to be understood that such a variation is always included in a given value provided herein, whether or not it is specifically referred to.

Embodiments of the present invention provide an improved self-contained hydroponic system with a unique trough for holding plant cultivation containers which provides improved gravity drainage to prevent plants from drowning or root rot, while improving oxygen intake. Embodiments of the cultivation system also comprise an irrigation system which provides a steady and consistent flow of hydroponic solution through the plant growing medium, and ensures optimal delivery of hydroponic solution and nutrients that run over the plant roots, into the trough system and via gravity drainage to a nutrient solution reservoir. Embodiments of the present system result in stronger root mass, increased plant canopy, faster growth, and overall higher quality plants.

The present invention further provides a unique lighting system for indoor plant cultivation systems, which provides for optimal illumination of the top and sides of one or more plants, which improves plant growth and strength, and provides 6 to 8 feet tall plants with improved growth of both top and side canopies.

The hydroponic cultivation system of the present invention comprises one or more cultivation containers, one or more elongated troughs to support the cultivation containers, and an irrigation system configured to deliver a hydroponic solution from a hydroponic solution source to the one or more plants.

Each of the cultivation containers comprise an outer container, such as a bucket, having a lower portion that includes a drain, which in some embodiments can be one or more holes defined in a lower portion, such as in the bottom of the bucket. The container also contains a perforated insert, such as a meshed-basket, for holding a growing medium and the root ball the plant. The outer bucket is configured to receive and support the perforated insert and/or the insert is configured to be received and supported by the bucket and support a root mass of the plant. In some embodiments, the insert has a flange portion provided at the upper end thereof to rest on a peripheral edge of the bucket. In some embodiments, the one or more holes in the lower portion of the one or more buckets are covered with a perforated screen.

One or more troughs of the cultivation system of the present invention each have a top portion, a bottom portion, a pair of generally opposing side walls that extend longitudinally between a first end and a second end of the trough. The bottom portion of the trough defines a longitudinal channel inclined downwards from the first end towards the second end, which has a trough outlet. The top portion of the trough has opposing shoulders extending outwardly from the side walls, which are configured to support the one more cultivation containers. The cultivation containers may be supported at a bottom or a portion of a side of the container.

In some embodiments, the trough further has opposing walls extending upwardly from an outer end of each shoulder.

In some embodiments, the second end and optionally the first end of the trough have an end wall, and the trough outlet is located at the bottom portion of the second end of the trough.

The irrigation system of the cultivation system comprises one or more hydroponic solution delivery units, each unit being associated with a respective cultivation container, and configured to deliver the hydroponic solution to the plant through the upper portion of the respective cultivation container. Upon delivery to the cultivation container, the hydroponic solution passes over the growing medium and root ball of the pnat, through the perforated insert, through the drain in the bucket into the channel of the trough, and through the trough outlet at the second end of the trough.

In some embodiments, the irrigation system further comprises a delivery conduit in fluid communication with the hydroponic solution source, and one or more feed lines that extend from the delivery conduit. Each feed line is in fluid communication with one or more delivery units. In one embodiment each feed line is configured to extend substantially parallel to a respective elongated trough, for example at a height close to the upper portion of the one or more buckets supported by the trough.

In some embodiments, the delivery unit comprises a delivery head and an extension line in fluid communication with the hydroponic solution source. In some embodiments, the extension line is in fluid communication with a respective feed line.

In some embodiments, the hydroponic solution source is a reservoir adapted to contain the hydroponic solution, and having an outlet in communication with the irrigation system.

In some embodiments, the cultivation system is further configured to recirculate hydroponic solution recovered from the trough outlet. In such embodiments, the reservoir is provided with an inlet configured to receive the recovered hydroponic solution. The irrigation system further comprises a pump adapted to pump the hydroponic solution from the reservoir via the outlet thereof to the one or more delivery heads, and a draining conduit system is provided in fluid communication with the trough outlet and the inlet of the reservoir, to collect and return the recovered hydroponic solution to the reservoir.

In some embodiments, the delivery head is configured to deliver the hydroponic solution at the top the growing medium and/or around the stem of a plant. In some embodiments, the delivery head is configured to encircle the plant. In some embodiments, the delivery head is ring shaped, c-shaped, triangular shaped or rectangular shaped. In preferred embodiment, the delivery head is fluidly connected to the feed line via an extension line.

In some embodiments, the delivery head has a top portion and a bottom portion having a plurality of pores or holes defined therein. The pores are provided in sufficient size, shape, and number to allow for adequate delivery of the hydroponic solution from the delivery head to the plant. In some embodiments, the pores are provided in radially oriented rows, each row having 3-6 pores. In some embodiments, the pores are about 2 mm to about 3 mm in diameter. In some embodiments, the pores are about 2.5 mm in diameter.

In some embodiments, the delivery head has a diameter suitable to fit within the upper portion of the cultivation container, and the perforated insert holding the plant.

In some embodiments, the buckets are insulated. In some embodiments, the buckets are wrapped with an insulation material such as bubble wrap, polymeric foam and like. In other embodiments, the buckets may be actively temperature controlled including electronic or computer controller control systems.

Any known growing medium used in the cultivation/hydroponic industry can be used in the present system. In some embodiments, the growing medium is selected from clay pellets, peat moss, vermiculite, perlite, gravel, or rockwool. Preferably, the growing medium is clay pellets.

In some embodiments, the trough is made of a non-porous material, such as stainless steel.

In some embodiments, the trough has a flat bottom. In some embodiments, the trough is provided with a vinyl liner, for example, on the flat bottom.

In some embodiments, the trough has a continuous inclination/slope. In some embodiments, the trough slopes about 0.5″ for every about 9-10′ of length. In some embodiments, the trough is provided on a supporting structure or a stand. In some embodiments, the trough stand is provided with wheels.

In some embodiments, the trough is provided with one or more cover members which may utilize materials such as High Density Polyethylene (HDPE), also known as “puck board”, which are adapted to cover the open sections of the trough between two adjacent cultivation containers.

In some embodiments, the pump of the irrigation system is configured to operate for intermittent irrigation cycles. In some embodiments, the pump is configured to operate for about 1.5 minutes for each 10 minute block, or for about 7-10 minutes in total for each 1 hour block.

In some embodiments, the irrigation system further comprises a temperature controller to modulate temperature of the hydroponic solution in the reservoir. In some embodiments, the controller is a “chiller” that serves to lower the temperature of the hydroponic solution.

The cultivation system can be used with a single trough and a single container, or a plurality of troughs with a plurality of containers in each trough. Containers may be spaced sufficiently close on a trough to allow for an efficient use of the trough, while being spaced sufficiently far apart to allow for light provided by a lighting system to illuminate the top canopy and circumference of the side canopy of each plant. Containers may also be spaced sufficiently far apart to prevent the crowding of the plants as they grow within the containers. In some embodiments, the troughs are sized to allow containers to be placed with about 1 to 3 feet spacing between two adjacent containers.

The troughs may be spaced sufficiently close to each other to allow for an efficient use of the space that the troughs are contained within, while maintaining sufficient space to allow for light provided by a lighting system to illuminate the tops and sides of the plant canopy. Troughs may also be spaced sufficiently far apart to prevent the crowding of the plants between adjacent troughs.

In some embodiments, the cultivation system comprises two or more troughs arranged parallel to each other. In such embodiments, the irrigation system comprises a feed line running the length of a respective trough to bring hydroponic solution to a row of cultivation containers supported by each trough, for delivery to each individual cultivation container via its respective delivery head.

In some embodiments, the one or more troughs are disposed at a higher elevation, such as in an upper levelof a growing facility, and the reservoir and pump are provided at a lower elevation, such as in a lower level of the growing facility.

In some embodiments, in operation, the hydroponic solution is pumped from the reservoir towards the one or more containers via delivery line and feed lines for delivery to each plant via respective delivery heads. The hydroponic solution flows to each individual plant through the delivery head and passed over the growing medium and the plant root mass, through the perforated insert holding the plant and through the drain in the bucket into the channel of the trough system. Gravity drainage brings the hydroponic solution through the trough and towards draining end of the trough and back to the reservoir.

In some embodiments, the hydroponic solution is run through a chiller to ensure the correct water temperature. Nutrients are added directly into the tank as needed and the solution can be recirculated through the system for 5 to 8, preferably 7 days at which point an overall reservoir flush and cleaning is completed.

In some embodiments, the system further comprises an aeration system to aerate and incorporate oxygen into the nutrient solution. In some embodiments, the system further comprises an aeration system to provide an individualized flow of air to each plant.

The present invention further provides a lighting system for illuminating one or more plants during a growing cycle. The system comprises at least one overhead light source configured to illuminate a top canopy of the one or more plants, and a plurality of vertical light assemblies, wherein each light assembly comprises one or more vertically oriented light sources, arranged such that each light source illuminates at least a portion of a circumference of side canopy a plant.

The light assemblies may be suspended from above using cables of a suitable material, such as galvanized steel, or may be supported from below using a suitable platform.

In some embodiments, each of the plurality of vertical light assemblies are configured to be independently vertically adjustable to illuminate a desired height of the one or more plants, and/or at least a portion of the side canopy of the one or more plants.

In some embodiments the vertical light assemblies are configured to illuminate the entire side canopy of the plant.

Vertical movement of the light assemblies allows positioning of the assemblies for illumination of plants of varying height. In some embodiments, the system is provided with an elevation mechanism, such as a winch system, to adjust the vertical positioning.

In some embodiments, the light assembly comprises at least two vertically oriented light sources, arranged such that each light assembly provides illumination in a substantially 180 degree to 360 degree area around the light assembly.

In some embodiments, the light assembly comprises two vertically oriented light sources arranged to provide illumination in a substantially 180 degree area around the light assembly. In some embodiments, the light assembly comprises four vertical vertically oriented light sources arranged to provide illumination to plants in a substantially 360 degree area around the light assembly.

In some embodiments, the direction of illumination of each of the plurality of vertically oriented light sources is independently adjustable in a horizontal plane to change the angle and direction of illumination.

In some embodiments, the vertically oriented light source is provided as one or both of an elongated tube or a vertical array of light bulbs. In preferred embodiments, vertically oriented light sources are LED lights.

In some embodiments, each of the plurality of vertical light assemblies has a length equal to or greater than a maximum growth height of the plant.

In some embodiments, each of the plurality of vertical light assemblies is configured to selectively illuminate a portion of each of the plurality of vertical light sources. Each vertically oriented light source may be comprised of one or more sections to enable the selective illumination of each section independently, in groups, or as a single unit.

In some embodiments, each of the plurality of vertically oriented light sources are configured to produce a quantity of heat that allows the plurality of vertical light sources to be placed from 1 to 6 inches from the side canopy without adversely affecting the growth of the plant.

In some embodiments, the plurality of vertical light assemblies is arranged on one side or opposing sides of a row of plants spaced apart in a defined distance, such that one light assembly is located adjacent the space between two adjacent plants, thereby being capable of illuminating both adjacent plants simultaneously.

In some embodiments, the plurality of vertical lighting assemblies is arranged between two substantially parallel rows of substantially equidistantly spaced apart plants, such that one assembly is located adjacent the space between two adjacent plants in adjacent rows, thereby being capable of illuminating two adjacent plants in the two adjacent rows simultaneously.

In some embodiments, a row of plants is provided on an elongated platform, such as a trough as described herein.

In some embodiments, the vertically oriented light sources are each mounted between a top bracket plate and bottom bracket plate. In some embodiments, the top and bottom bracket plates are configured to swivel in a horizontal direction to change the angle and direction of the illumination.

The bracket plates may be manufactured of a rigid material such as aluminium, plastic, steel, or other suitable material.

The bracket plates may be configured to hold the vertical lights in groups of two, six, eight, or other numbers in order to provide illumination in a 180 degree to 360 degree area around the light assembly. This arrangement allows for a single light structure to be placed between two or more of cultivation containers and simultaneously illuminate at least a portion of the side canopies of a plurality of plants growing in the cultivation containers.

The light assembly may take a number of configurations. A light assembly with four vertically oriented light sources may have a square or rectangular configuration when viewed from above. For light assemblies with a different number of vertical lights, the configuration of the light assembly may change to provide better all-around illumination of the plants arranged around it, or to provide illumination in one predetermined direction. In some embodiments, lighting system is for use in illuminating cannabis plants.

In some embodiments, a lighting system for a plant in a cultivation container is provided, comprising at least one overhead light source provided above the plant to illuminate a top canopy of the plant, and a plurality of vertical light sources arranged to illuminate the circumference of the side canopy of the plant. In embodiments employing four vertical light sources, each of the vertical light sources may be positioned at four corners of the plant to provide even or uniform lighting of the side canopy of the plant. In some embodiments, each of the four vertical light sources may be placed between 1 and 6 inches from the side canopy of the plant.

In cases where multiple cultivation containers are arranged in regular rows, vertical light assemblies that include four vertical light sources may be placed equidistant between each group of four adjacent plants, so that a single light assembly may provide illumination to at least a portion of each plant. By interspersing plants and vertical light assemblies, the side canopies of multiple plants may be provided with illumination in a uniform and efficient manner.

In some embodiments, the lighting system as described herein is for use with the cultivation system described herein, wherein the plants being illuminated are provided in the one or more cultivation containers supported by the one or more troughs.

In another aspect, the present invention provides a method of cultivating one or more plants, which involves the steps of illuminating a top canopy of the one or more plants with one or more overhead light sources; illuminating at least a portion of a side canopy of the one or more plants with a plurality of vertical light assemblies, each light assembly comprising one or more vertically oriented light sources, arranged such that each light source illuminates a portion of a circumference of the side canopy , the vertical light assemblies being positioned such that one assembly is located adjacent a space between two adjacent plants; and irrigating the one or more plants, preferably in intermittent irrigation cycles.

In some embodiments, the irrigation cycles in the method comprise irrigating the one or more plants for about 1.5 minutes for each 10 minute block, or for about 7-10 minutes in total for each 1 hour block.

In some embodiments, the method comprises arranging the plurality of vertical lighting assemblies on one side or opposing sides of a row of plants spaced apart in a defined distance, such that one assembly is located adjacent the space between two adjacent plants. In some embodiments, the method comprises arranging the plurality of vertical lighting assemblies between a plurality of substantially parallel rows of plants having substantially equidistantly spaced apart plants, such that one assembly is located adjacent the space between two adjacent plants in two adjacent rows.

In some embodiments, the method comprises positioning each of the plurality of vertical light assemblies to illuminate at least a portion of a height of the one or more plants.

In some embodiments, the method further comprises adjusting the direction of illumination of each of the plurality of vertically oriented light sources in a horizontal plane to change the angle and direction of the illumination.

In some embodiments, the method involves use of the cultivating system as described herein.

The cultivation system of the present invention provides for commercial scale cultivation of plants in a clean environmentally friendly setting and environment which is easy to maintain. In some embodiments, the cultivation system provides for higher cannabis production, including better quality flowers and buds, and an increased harvestable canopy in the same square footage leading to a higher yield per square foot.

In the embodiments, where the irrigation system includes one feed line for a row of containers held in a trough, and a delivery head per plant, configured to deliver the solution at an upper portion of the container to ensure optimal delivery of water and nutrients that run over the plant roots, down into the specific trough system, and via gravity drainage to the reservoir. The trough of the present system reduces clogging and system failures through the use of buckets supported by the shoulders of the troughs, which prevents roots from growing in the channel. The trough system of the present invention therefore promotes full growth of the plant, provides flexibility with respect to the number of plants per row and can handle large amounts of water flow. The system of the present invention prevents over watering of plants and protects the plants from any mould or root rot. In some embodiments, the system of the present invention can provide an efficient closed loop system by allowing nutrient solution to return to the reservoir for recirculation through the irrigation system, thereby resulting in substantial reduction in water consumption than conventional systems.

The use of a combination of overhead and vertical lighting provides illumination of the plant from top to bottom, which allows the plants to grow taller with stronger stems having a top canopy, and side canopies with larger denser flowers and buds, resulting in surprisingly higher yields per square feet than the yields obtained by previously known commercial growing methods. The placement of vertical light assemblies adjacent the spaces between two adjacent plants, and the provision of the elevation mechanism creates a system wherein lights can be raised and lowered to provide illumination to a desired height of a plant, and to allow access between rows of troughs to tend to the plants during the cultivation process.

To gain a better understanding of the invention described herein, the following examples are set forth. It will be understood that these examples are intended to describe illustrative embodiments of the invention and are not intended to limit the scope of the invention in any way.

### EXAMPLES

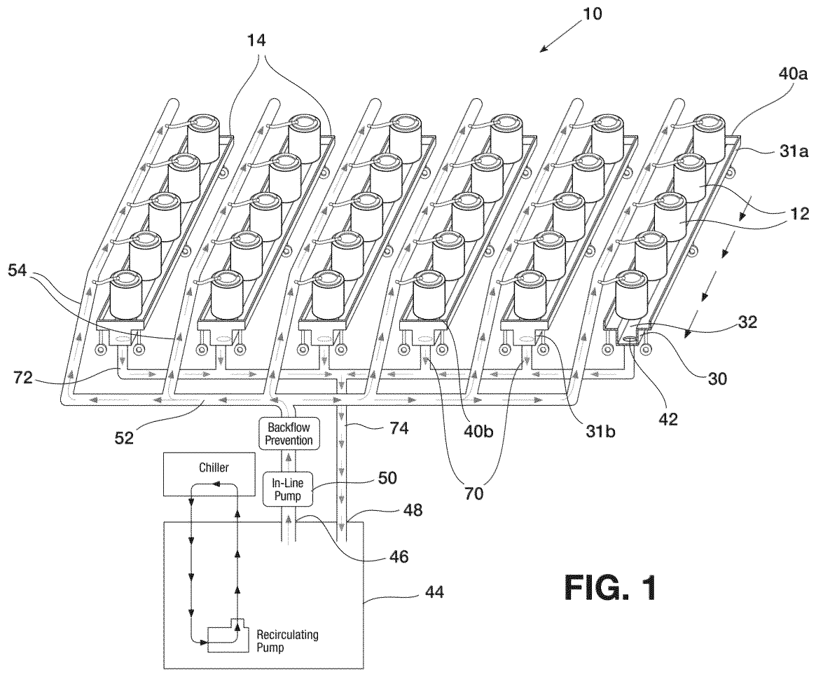

FIG. 1 is a schematic depiction of an exemplary hydroponic cultivation system 10 of the present invention. In this embodiment, the system comprises a plurality of cultivation containers 12 and a plurality of elongated troughs 14 each supporting a row of containers.

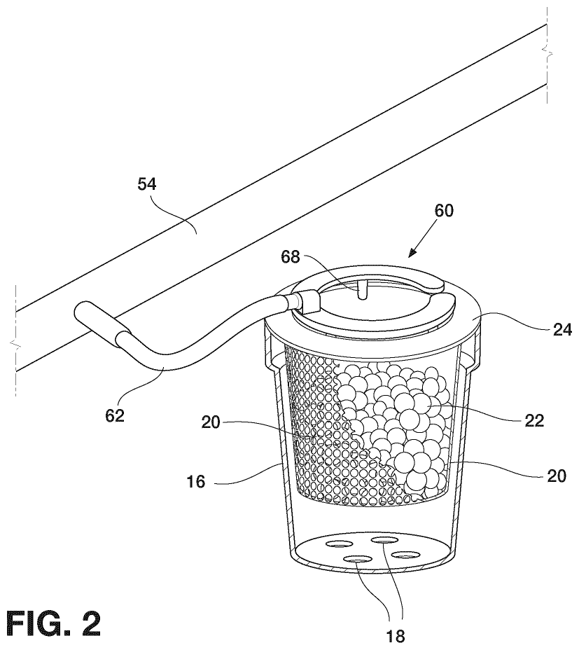

With reference to FIG. 2, each container 12 comprises an outer bucket 16 having a drain defined by one or more holes 18 provided in the bottom thereof, and a perforated insert/basket 20 provided with a growing medium 22 to hold a plant and support a root mass of the plant . The bucket 16 is configured to receive and support the insert 20. In this example, the insert has a flange portion 24 provided at the upper end thereof configured to rest on a peripheral edge of the bucket.

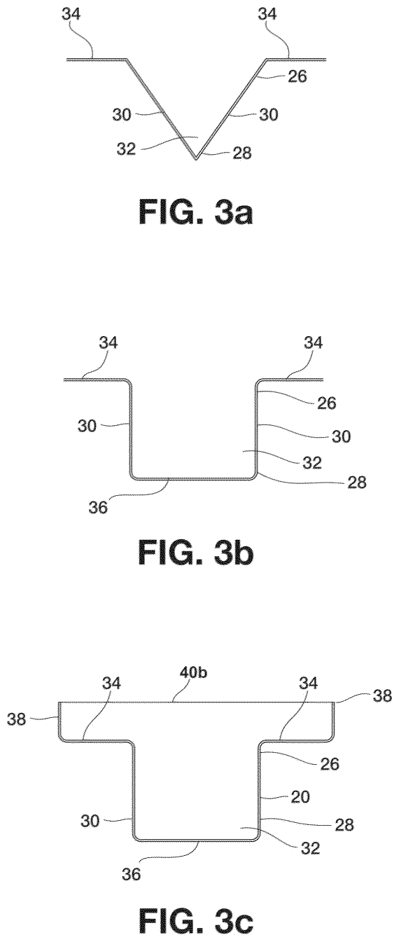

With reference to FIGS. 1, 3A to 3C, each trough comprises an upper portion 26 lower portion 28, and pair of generally opposing side walls 30 that extend longitudinally between a first end 31a and a second end 31b and define a longitudinal channel 32 at the lower portion of the trough. Each trough is inclined downwards from the first end 31a towards the second end 31b. Opposing shoulders 34 extend outwardly from each sidewall 30. The shoulders are sized and shaped to support the cultivation containers.

In some embodiments, the trough has a flat bottom 36, as shown in FIGS. 3B and 3C, which can be lined with a vinyl lining (not shown).

In some embodiments, the trough has opposing walls 38 extending upwardly from an outer end of each shoulder 34, and end walls 40a and 40b extending upwardly from the ends 31a and 31b, respectively (FIGS. 1 and 3C).

The system shown in FIG. 1 comprises the troughs depicted in FIG. 3C, wherein a trough outlet 42 is provided at the second end 31b for draining the hydroponic solution from the trough. The shape of second end 31b may also have a wedge, hemispherical, or other shape to channel the hydroponic solution towards reservoir 44.

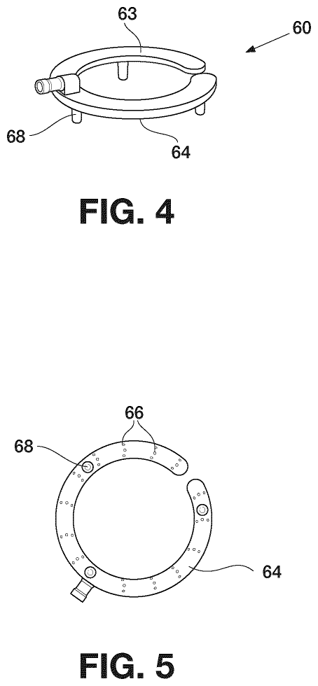

The system of FIG. 1 further comprises an irrigation system configured to deliver a hydroponic solution to each of the cultivation containers. The irrigation system comprises a reservoir 44 adapted to contain the hydroponic solution. The reservoir has an outlet 46 and an inlet 48. A pump 50 is adapted to pump the hydroponic solution from the reservoir via the outlet 48 to a delivery conduit 52 in fluid communication with the pump. Feed lines 54 extend from the delivery conduit and each feed line extend parallel to a respective elongate trough. A plurality of delivery units extend from a respective feed line, such that each delivery unit is associated with a respective cultivation container 12. With reference to FIG. 2, each delivery unit has horseshoe or c-shaped delivery head 60 and an extension line 62 connecting the delivery head with the feed line 54. With reference to FIG. 4 and FIG. 5, each delivery head 60 has a top portion 63 and a bottom portion 64 having a plurality of pores 66 defined therein to deliver the hydroponic solution to the plant from a top end of the respective cultivation container. In this embodiment, each delivery head is provided with pegs 68 on the bottom portion. The pegs are sized and configured to removably anchor the head into the growing medium.

As shown in FIG. 1, a draining conduit system is provided in fluid communication with the outlets 42 of each trough and the inlet 48 of the reservoir, to collect and return the recovered hydroponic solution to the reservoir. The draining conduit system comprises a plurality of collection conduits 70, each having an inlet in fluid communication with the outlet 42 of a respective trough, and an outlet in communication with a transport conduit 72, which in turn is in communication with a return conduit 74 in communication with the inlet 48 of the reservoir.

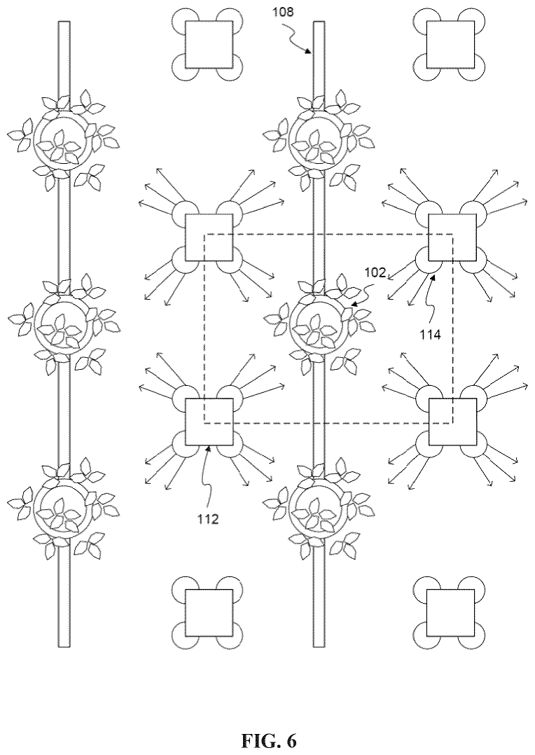

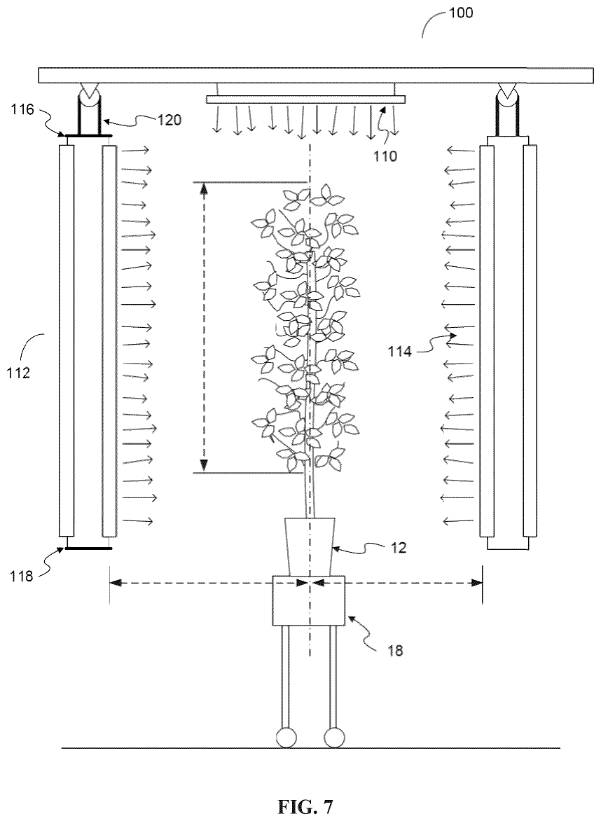

FIGS. 6 and 7 are schematic depictions of the lighting system 100 of the present invention. The lighting system 100 includes one or more overhead lights 110 to illuminate the top of plants 102, and includes a plurality of vertical light assemblies 112 that are arranged on one or opposing sides of a row of plants, and positioned adjacent the space between two adjacent plants. In this example. each assembly 112 has four vertical lights 114 arranged to provide illumination to plants in a substantially 360 degree area around the light assembly 112, such that each light illuminates a portion of a circumference of a plant. Light assemblies 112 can also be configured to only provide illumination in a 180 degree area or a 90 degree area and be configured with two or one vertical light 114, respectively. For example a light assembly mounted against a wall with a row of plants only on one side can be configured with only two vertical lights 114. The plants can be placed on a platform 108.

With reference to FIG. 6, each vertical lighting assembly 112 comprising four vertical lights 114, which can be arranged in a square or rectangular shape around a plant when viewed from above. The vertical lights are arranged such that each light illuminates a portion of a circumference of the plant.

With reference to FIG. 7, the vertical lights are mounted on top and bottom bracket plates 116, 118 to securely hold the vertical lights, and the light assemblies 112 are suspended from above using cables 120, and the assemblies are movable in the vertical direction using a winching system allowing for illumination of plants of different height.

The lighting system illustrated in FIGS. 6 and 7 can be used with the cultivation system schematically depicted in FIG. 1, wherein troughs 18 are placed parallel to each other and at regular intervals, and the cultivation containers 12 distributed at regular intervals along troughs 18. As illustrated in FIG. 6, this allows overhead lights and the vertical light assembly 110 to be placed above and around the circumference of the canopy of a plant in a cultivation container, thereby providing uniform illumination around the top and side canopy of the plant. Since overhead lights 110 and vertical lights 112 comprise LED light elements, the lights can be placed at a close distance to the plant canopy without over heating, damaging, or otherwise adversely affecting the growth of the plant. In embodiments, vertical lights 112 of the light assembly can be placed from 1 to 6 inches from the plant canopies.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A system for hydroponic cultivation, comprising:
one or more cultivation containers, each including:
an outer bucket having a drain provided in a lower portion thereof,
a perforated insert for holding a growing medium and a plant, and supporting a root mass of the plant,
the outer bucket being configured to receive and support the perforated insert;
one or more elongated troughs, each having a top portion, a bottom portion, a pair of generally opposing side walls extending longitudinally between a first end and a second end comprising a trough outlet,
the bottom portion of the trough defining a longitudinal channel inclined downwards from the first end towards the second end,
the top portion having opposing shoulders extending outwardly from the side walls, the shoulders configured to support the one more cultivation containers; and
an irrigation system configured to deliver a hydroponic solution from a hydroponic solution source to the one or more plants, the irrigation system comprising:
one or more delivery units, each delivery unit being associated with a respective cultivation container, and configured to deliver the hydroponic solution to the plant through an upper portion of the respective cultivation container,
wherein upon delivery to the cultivation container, the hydroponic solution passes over the growing medium, through the perforated insert, through the drain in the bucket into the channel of the trough, and through the trough outlet at the second end of the trough.

2. The cultivation system of claim 1, wherein the irrigation system further comprises:
a delivery conduit in fluid communication with the hydroponic solution source;
one or more feed lines extending from the delivery conduit, wherein each feed line is in fluid communication with one or more delivery units.

3. The cultivation system of claim 2, wherein the delivery unit comprises a delivery head and an extension line in fluid communication with a respective feed line.

4. The cultivation system of claim 3, wherein the delivery head is ring shaped, c-shaped, triangular shaped or rectangular shaped.

5. The cultivation system of claim 4, wherein the delivery head has a top portion and a bottom portion having a plurality of pores defined therein.

6. The cultivation system of claim 5, wherein the pores are provided in radially oriented rows, each row having 3-6 pores.

7. The cultivation system of claim 6, wherein the pores are about 2 mm to about 3 mm in diameter.

8. The cultivation system of claim 1, wherein the hydroponic solution source is a reservoir adapted to contain the hydroponic solution, the reservoir having an outlet in fluid communication with the irrigation system.

9. The cultivation system of claim 8, wherein the system is further configured to recirculate hydroponic solution recovered from the trough outlet, wherein the reservoir has an inlet to receive the recovered hydroponic solution, and wherein the irrigation system further comprises:
a pump adapted to pump the hydroponic solution from the reservoir via the outlet thereof to the one or more delivery heads, and
a draining conduit system in fluid communication with the trough outlet and the inlet of the reservoir, to collect and return the recovered hydroponic solution to the reservoir.

10. The cultivation system of claims 9, wherein the pump is configured to operate for intermittent irrigation cycles.

11. The cultivation system of claim 10, wherein the pump is configured to operate for about 1.5 minutes for each 10 minute block, or for about 7-10 minutes for each 1 hour block.

12. The cultivation system of claim 8, wherein the irrigation system further comprises a temperature controller to modulate the temperature of the hydroponic solution in the reservoir.

13. The cultivation system of claim 1, wherein at least the second end of the trough has an end wall, and the trough outlet is located at the bottom portion of the trough.

14. The cultivation system of claim 1, wherein the trough further has opposing walls extending upwardly from an outer end of each shoulder.

15. The cultivation system of claim 1, wherein the insert has a flange portion provided at the upper end thereof configured to rest on a peripheral edge of the bucket.

16. The cultivation system of claim 1, wherein the trough is made of a non-porous material.

17. The cultivation system of claim 1, wherein the trough has a flat bottom.

18. The cultivation system of claim 17, wherein the trough is provided with a vinyl liner.

19. The cultivation system of claim 1, further comprising one or more cover members, each said cover member being adapted to cover the trough between two adjacent cultivation containers.

20. The cultivation system of claim 1, wherein the system comprises a plurality of troughs arranged parallel to each other, wherein each trough supports a plurality of the cultivation containers.

21. A lighting system for illuminating one or more plants during a growing cycle, the system comprising:
at least one overhead light source configured to illuminate a top canopy of the one or more plants;
a plurality of vertical light assemblies, each light assembly comprising one or more vertically oriented light sources, arranged such that each light source illuminates a portion of a circumference of a side canopy of a plant.

22. The lighting system of claim 21, wherein each of the plurality of vertical light assemblies is independently vertically adjustable to illuminate a desired height and/or at least a portion of the side canopy of the one or more plants.

23. The lighting system of claim 21, wherein one or more of the plurality of light assemblies comprise at least two vertically oriented light sources, arranged such that each vertical light assembly provides illumination in a substantially 180 degree to 360 degree area around the vertical light assembly.

24. The lighting system of claim 21, wherein one or more of the plurality of vertical light assemblies comprise two vertically oriented light sources arranged to provide illumination in a substantially 180 degree area around the vertical light assembly.

25. The lighting system of claim 21, wherein one or more of the plurality of vertical light assemblies comprise four vertically oriented light sources arranged to provide illumination in a substantially 360 degree area around the light assembly.

26. The system of claim 21, wherein the direction of illumination of each of the plurality of vertically oriented light sources is independently adjustable in a horizontal plane to change the angle and direction of the illumination.

27. The lighting system of claim 26, wherein the vertically oriented light sources are each mounted between a top bracket plate and bottom bracket plate.

28. The lighting system of claim 27, wherein the top and bottom bracket plates are configured to swivel in a horizontal direction to change the angle and direction of illumination.

29. The lighting system of claim 21, wherein the vertically oriented light source is provided as an elongated tube and/or a vertical array of light bulbs.

30. The lighting system of claim 21, wherein vertically oriented light sources are LED lights.

31. The lighting system of claim 21, wherein each of the plurality of vertical light assemblies has a length equal to or greater than a maximum growth height of the plant.

32. The lighting system of claim 21, wherein each of the plurality of vertical light assemblies is configured to selectively light a portion of each of the plurality of vertical light sources.

33. The lighting system of claim 21, wherein each of the plurality of vertically oriented light sources is configured to produce a quantity of heat that allows the light assemblies to be placed such that the light sources are located from 1 to 6 inches from the side canopy without adversely affecting the growth of the plant.

34. The lighting system of claim 21, wherein the plants are cannabis plants.

35. The lighting system of claim 21, wherein the plurality of vertical light assemblies is arranged on one side or opposing sides of a row of plants spaced apart in a defined distance, such that one light assembly is located adjacent the space between two adjacent plants.

36. The lighting system of claim 21, wherein the plurality of vertical lighting assemblies is arranged between a plurality of substantially parallel rows of substantially equidistantly spaced apart plants, such that one light assembly is located adjacent the space between two adjacent plants in adjacent rows.

37. The cultivation system of claim 1, further comprising a lighting system as defined in claim 21.

38. The cultivation system of claim 37, wherein the system comprises a plurality of troughs arranged parallel to each other and spaced apart from each other at a predefined distance, each trough supporting a plurality of the cultivation containers spaced apart at a predefined distance.

39. A method of cultivating one or more plants, the method comprising:
illuminating a top canopy of the one or more plants with one or more overhead light sources;
illuminating at least a portion of a side canopy of the one or more plants with a plurality of vertical light assemblies, each light assembly comprising one or more vertically oriented light sources, arranged such that each light source illuminates a portion of a circumference of the side canopy, the vertical light assemblies being positioned such that one assembly is located adjacent a space between two adjacent plants; and
irrigating the one or more plants, preferably in intermittent irrigation cycles.

40. The method of claim 39, wherein the irrigation cycles comprise irrigating the one or more plants for about 1.5 minutes for each 10 minute block, or for about 7-10 minutes in total for each 1 hour block.

41. The method of claim 39, wherein the plurality of vertical lighting assemblies are arranged on one side or opposing sides of a row of plants spaced apart in a defined distance, such that one assembly is located adjacent the space between two adjacent plants.

42. The method of claim 39, wherein the plurality of vertical lighting assemblies are arranged between a plurality of substantially parallel rows of plants having substantially equidistantly spaced apart plants, such that one assembly is located adjacent the space between two adjacent plants in two adjacent rows.

43. The method of claim 39, comprising positioning each of the plurality of vertical light assemblies to illuminate at least a portion of a height of the one or more plants.

44. The method of claim 39, further comprising adjusting the direction of illumination of each of the plurality of vertically oriented light sources in a horizontal plane to change the angle and direction of the illumination.

45. The method of claim 40, wherein the plurality of vertical light assemblies are placed such that the light sources are located from 1 to 6 inches from one or more side canopies of the plants.

46. The method of claim 40, wherein the plants are cannabis plants.

47. (canceled)
